(19) United States
(12) Patent Application Publication
(10) Pub. No.: US 2025/0392129 A1
(43) Pub. Date: Dec. 25, 2025

(54) METHOD AND CONTROL CIRCUIT FOR REDUCING HARMONIC POWER FLOWS, AND SUB-NETWORK HAVING CONTROL UNIT

(71) Applicant: SMA Solar Technology AG, Niestetal (DE)

(72) Inventors: Alexander Unru, Baunatal (DE); Mohamed Khshainy, Kassel (DE); Chokri Khalfet, Kassel (DE); Marcel Kratochvil, Kassel (DE)

(21) Appl. No.: 19/317,538

(22) Filed: Sep. 3, 2025

Related U.S. Application Data
(63) Continuation of application No. PCT/EP2024/052278, filed on Jan. 30, 2024.

(30) Foreign Application Priority Data
Mar. 10, 2023 (DE) 10 2023 106 050.3

(51) Int. Cl. H02J 3/01; H02J 3/00

(52) U.S. Cl. CPC H02J 3/01; H02J 3/0012

(57) ABSTRACT

A method for reducing harmonic power flows via a connection point at which a sub-network is connected to a higher-level AC supply network and via which a network current flows between the sub-network and the higher-level AC supply network is disclosed.

### REFERENCE TO RELATED APPLICATIONS

This application is a Continuation of International Application number PCT/EP2024/052278, filed on Jan. 30, 2024, which claims the benefit of German Application number 10 2023 106 050.3, filed on Mar. 10, 2023. The contents of the above-referenced patent applications are hereby incorporated by reference in their entirety.

### FIELD

The application relates to a method and a control unit for reducing harmonic power flows, as well as to an alternating voltage sub-network (AC sub-network) connected to a higher-level alternating voltage supply network (AC supply network) with such a control unit.

### BACKGROUND

AC sub-networks can be used in the industrial sector, for example, to supply industrial plants and/or industrial areas. An AC sub-network can consist of one or more AC cable strands that are connected together at a connection point and to which electrical loads can be connected. In this case, the loads connected to the sub-network are supplied with electrical power with a current component at a nominal frequency of the sub-network, e.g. at 50 Hz network frequency, and can draw additional harmonic current components from the sub-network, i.e. currents with multiples of the network frequency. In general, these arise from consumers and equipment that have a non-sinusoidal current or a current flow that is periodically switched on and off, such as rectifiers, frequency converters or UPS systems and/or similar, particularly clocked, loads. In this case, multiples of up to 50 times the network frequency can be observed. The consequence of the current distortion from these harmonics is a distortion of the nominal sinusoidal network voltage with comparable frequency components to the harmonic current components.

In this case, the voltages and/or the currents in sub-networks for industrial plants and other larger objects with a high demand for electrical power, e.g. production plants with machine parks or shopping centers and the like, can contain distortions that exceed certain limits with regard to THD (total harmonic distortion) and/or harmonics in voltage and/or current. Such sub-networks and/or certain consumers supplied via individual strands of the sub-network may therefore not be automatically connected to a higher-level supply network if the aforementioned limit values are defined for such a connection point.

Passive filters are known in which passive elements such as capacitors and inductors are used. Such filters are designed, for example, as so-called absorption circuits and are usually designed or dimensioned for a specific load with given properties.

EP2436092 describes the compensation of harmonics occurring in current curves in a high-voltage network by means of a passive filter and a controllable voltage source.

A STATCOM is a power converter that is designed to exchange inductive or capacitive reactive power with an AC network. In this case, a DC capacitor acts as a DC voltage source which, via a power converter, forms an AC voltage source for connection to the AC network via a transformer.

EP2478610 describes a photovoltaic system that is connected to an AC supply network via a transformer and is designed both to generate active power and exchange it with the AC supply network by means of a current control system, as well as to compensate for reactive power and harmonics in the AC supply network so that the photovoltaic system operates as a type of STATCOM with a current control system.

From DE 102 44 056 B3, a method for generating a set of control signals for a converter of an active filter for compensating harmonics is known. In this method, the current that contains the harmonic to be compensated is measured, and the fundamental component is eliminated from the measurement signals. A transformed control function of a PI controller is applied to the measured values filtered in this way. The output variables of the PI controller are then summed and transmitted as a setpoint current value to the control device of an IGBT converter.

### SUMMARY

The application is based on the problem of providing a method and a control circuit with which the quality of a sub-network can be improved with regard to the electrical parameters within the sub-network and/or at a connection point of the sub-network to a higher-level supply network.

A sub-network, for example, an AC sub-network, is connected to a higher-level AC supply network at a connection point. A network current flows between the sub-network and the higher-level AC supply network via the connection point, from the higher-level AC supply network into the sub-network. The AC supply network is at a higher level than the sub-network because, for example, it transports electrical energy over greater distances than the sub-network, the network voltage in the higher-level AC supply network is higher than in the sub-network, and/or the AC supply network is provided by a network operator for a larger area to supply energy with defined network parameters.

The sub-network has at least one electrical load that draws an electrical load current from the AC sub-network, which includes an active power current at a network frequency as well as a harmonic distortion current at one or more integer multiples of the network frequency. The at least one electrical load may be, for example, an alternating current load, such as a motor, or a direct current load which is connected to the AC sub-network for example via a rectifier. Depending on the power requirement of the load or the mode of operation of the converter, the above-mentioned components of the load current can be generated, for example, by a phase angle control, via which the electrical power of an AC load can be adjusted.

The sub-network further has a power converter which, through use of a bridge circuit exchanges electrical power between a direct current unit, for example, a capacitor, connected on its DC side, and the sub-network connected on its AC side. For this purpose, the bridge circuit can, for example, have semiconductor power switches which are controlled in a clocked manner. In this case, the power converter can be operated bidirectionally and can therefore act as an inverter with electrical power flow from the DC side to the AC side and as a rectifier with electrical power flow from the AC side to the DC side.

A method for reducing harmonic power flows across the connection point comprises:
detecting a network voltage of the sub-network,
determining a compensation voltage and/or a compensation current using the network voltage, the compensation voltage and/or the compensation current being provided to be produced by the power converter and being suitable for reducing the harmonic distortion current at at least a multiple of the network frequency in the network current, and
producing the compensation voltage and/or the compensation current by the power converter by suitable clocking of the bridge circuit between the DC-side capacitor and the sub-network.

In one embodiment the sub-network can be galvanically isolated from the higher-level AC supply network. Galvanic isolation can be achieved, for example, by a transformer at the connection point. In this case, in addition to galvanic isolation, the transformer can cause a transformation of the voltage between the AC supply network and the sub-network. Galvanic isolation at the connection point is an important safety feature for connection to AC supply networks. The sub-network can intrinsically be configured to not require internal galvanic isolation. For example, the power converter can be connected to the sub-network without galvanic isolation.

The described method can improve the network voltage quality in the sub-network. This can be advantageous, for example, for industrial applications that may have loads that negatively affect the network voltage. The method can improve the network current quality and thus improve the network voltage via the network impedance. Both quality improvements can have a targeted impact on improving the power exchanged via the connection point with the higher-level AC supply network and reducing negative effects of the power exchange via the connection point on the higher-level AC supply network.

In one embodiment, on its DC side, the power converter can alternatively or additionally be connected to an electrical DC source, such as a PV system (PV: photovoltaic). In inverter mode, the power converter can draw electrical power from the DC source and feed it into the sub-network. This electrical power available from the DC source can, for example, be used to cover the power requirement in the sub-network. This is advantageous in the industrial sector, for example, because it allows the self-consumption of locally generated power to be maximized. In addition, a network-friendly compensation function can be realized by providing distortion reactive power to smooth the current at the connection point. In this case, this network-friendly compensation function can be prescribed by regulation and/or carried out at the request of the AC supply network and/or the network operator. With the aid of the claimed method, it is possible to meet this requirement and at the same time reduce the effort for any AC network filters, which enables cost reductions.

In one embodiment, within a sub-network, a compensation voltage and/or a compensation current is provided locally, which provides the required harmonic distortion current to the at least one load so that the harmonic distortion current to be provided by the AC supply network and thus the harmonic power flows via the connection point are reduced.

In embodiments of the method, different harmonics of the harmonic distortion current at different multiples of the network frequency can be taken into account independently of one another when determining the compensation voltage and/or the compensation current.

In one embodiment of the method, a harmonic controller determines a respective contribution of the respective harmonic to the network voltage using the network voltage. In this case, respective harmonic contribution is an oscillation of the network voltage with a frequency that is a respective multiple of the network frequency, this oscillation of the network voltage being electrically coupled to a corresponding oscillation of the distortion current. In this case, the harmonic controller determines a respective harmonic compensation contribution to the compensation voltage using the respective harmonic contribution as a control variable. For example, odd multiples of the network frequency can be used here.

It is further proposed in one embodiment that a DC voltage be detected which is applied to the capacitor connected on the DC side of the power converter. A DC control determines a DC control contribution to the compensation voltage and/or the compensation current using the DC voltage in such a way that the DC voltage is regulated to a predetermined level by suitable active power exchange via the bridge circuit. This control compensates for any active power exchange due to the other contributions to the compensation voltage or the compensation current, for example, an active power due to the harmonic compensation amounts, without interfering with the control of the other contributions so that the capacitor of the power converter is permanently available as a source for the compensation voltage or the compensation current.

In embodiments, the DC control comprises an f(P) PI controller (PI controller=proportional-integral controller) which uses, as the input value, a difference between an active power current setpoint and an active power current actual value of the active power exchanged via the bridge circuit. In this case, the active power current setpoint is determined depending on a difference between an actual value of the DC voltage and the specified level of the DC voltage. In this case, the active power exchange is controlled via the bridge circuit by changing the AC-side frequency of the power converter depending on the output value of the f(P) PI controller. The AC-side frequency of the power converter corresponds to the output frequency of the electrical quantities present on the AC side of the power converter. Specifically, for example, the output frequency of the power converter can be changed by a change amount that is composed of a first amount that is generated using the P component of the f(P) PI controller and is proportional to the difference between the active power current setpoint and the active power current value, and a second amount that is generated using the I component of the f(P) PI controller and is proportional to the time integral of the difference between the active power current setpoint and the actual value. The embodiment with an f(P) PI controller enables network-forming control of the power converter by adjusting a phase angle difference between the output voltage of the power converter and the network voltage by changing the AC-side frequency of the power converter. This allows, on the one hand, the active power current setpoint to be set precisely, and, on the other hand, the control system reacts to a network event, for example, a phase jump in the network voltage or a change in the network frequency, at least temporarily with a corresponding active power change.

In an alternative embodiment, the DC control comprises a P controller (proportional controller) which uses, as the input value, a difference between an actual value of the DC voltage and the specified level of the DC voltage. The active power exchange via the bridge circuit is controlled by specifying a current setpoint depending on the output value of the P controller. Specifically, for example, a current setpoint can be generated that is proportional to the difference between the actual value and the setpoint of the DC voltage. The embodiment with a P controller enables efficient DC voltage maintenance within the characteristic linearized voltage range of the DC unit. Furthermore, DC control with a P controller enables rapid adjustment of the actual value to the setpoint of the DC voltage.

The load current may have a reactive power current at the network frequency. In order to reduce the generally resulting reactive power exchange at the connection point of the sub-network to the higher-level AC supply network, the method can include in one embodiment reactive power control. The reactive power control determines a reactive power control contribution to the compensation voltage. The reactive power control includes a U(Q) PI controller that uses, as the input value, a difference between a reactive power current setpoint and a reactive power current actual value of the reactive power exchanged via the bridge circuit. In this case, the reactive power current setpoint is specified for the reactive power depending on a difference between a setpoint and an actual value of the amount of the network voltage in such a way that the reactive power exchange at the connection point is reduced.

The method may include the following further acts:
detecting the load current and the network current,
determining a network current setpoint using the load current,
determining a target output voltage of the power converter depending on the difference between an actual network current value and the network current setpoint, and
producing a control signal from the determined target output voltage and clocking the bridge circuit depending on the control signal in order to generate the compensation current.

The control signal can, in one embodiment, be a pulse width modulation signal which specifies the clocking of the semiconductor switches of the bridge circuit, e.g. by specifying suitable opening and closing times of the semiconductor switches in each case.

In one embodiment, determining the network current setpoint may include bandpass filtering of the load current, with the center frequency of the bandpass depending on the network frequency. In this case, the center frequency of the bandpass filter can basically correspond to the network frequency.

In embodiments of the method, the load current, the output current of the power converter and/or the network voltage can be detected and used to pre-control the output voltage of the power converter.

The sub-network that is connected to the higher-level AC supply network via the connection point has at least one load that draws the load current from the sub-network. The load current includes an active power current at a network frequency as well as a harmonic distortion current at one or more integer multiples of the network frequency. The sub-network further has a power converter which, by means of a bridge circuit, exchanges electrical power between a capacitor connected on its DC side and the sub-network connected on its AC side.

A control unit for reducing harmonic power flows in the network current which flows through the connection point between the sub-network and the higher-level AC supply network is configured to:
receive a network voltage of the sub-network,
determine a compensation voltage and/or a compensation current using the network voltage, the compensation voltage and/or the compensation current being provided to be produced by the power converter and being suitable for reducing the harmonic distortion current at at least a multiple of the network frequency in the network current, and
output a control signal to the power converter, the compensation voltage and/or the compensation current being able to be generated by the power converter using the control signal by suitable clocking of the bridge circuit between the DC-side capacitor and the sub-network.

In one embodiment, the control unit is configured to determine a respective harmonic compensation contribution to the compensation voltage for various harmonic contributions at different multiples of the network frequency independently of each other.

The control unit can be configured to implement a respective harmonic controller by means of which, using the network voltage, a respective harmonic contribution can be determined, the respective harmonic compensation contribution to the compensation voltage being able to be determined using the respective harmonic contribution as a control variable.

In embodiments, the control unit can be configured to receive a DC voltage which is applied to the capacitor connected on the DC side of the power converter, and to carry out a DC control by means of which a DC control contribution to the compensation voltage and/or compensation current can be determined using the DC voltage in such a way that the DC voltage is regulated to a predeterminable level by suitable active power exchange via the bridge circuit.

The load current can further comprise a reactive power current at the network frequency, and the control unit can be configured to carry out a reactive power control by means of which a reactive power control contribution to the compensation voltage can be determined in such a way that the reactive power exchange at the connection point is reduced.

The sub-network that is connected to the higher-level AC supply network at the connection point may have such a control unit. The sub-network has at least one cable strand to which at least one load is connected, which is designed to draw the load current from the sub-network, which includes the active power current at the network frequency as well as the harmonic distortion current at one or more integer multiples of the network frequency. In embodiments, the load current may also include the reactive power current at the network frequency. The sub-network further has the power converter, which is designed to exchange electrical power between the direct current unit connected on its DC side, for example, a capacitor, and the sub-network connected on its AC side by means of the bridge circuit in such a way that harmonic power flows via the connection point are reduced.

The sub-network may comprise a plurality of power converters, for example, on the same cable strand of the sub-network, the different power converters each being configured to generate a compensation voltage and/or a compensation current to reduce different harmonic contributions at different multiples of the network frequency.

In this case, the power converters can be connected to a higher-level control unit. Alternatively or additionally, corresponding control units can be arranged decentrally on individual or all power converters in the sub-network. The higher-level or decentralized control unit can output a respective control signal to a respective one of the plurality of power converters, the respective control signal being suitable for generating the compensation voltage and/or the compensation current by the respective power converter for reducing the harmonic distortion current at one or more multiples of the network frequency. If the load current has a reactive power current at the network frequency, the respective control signal for generating the compensation voltage and/or the compensation current by the respective power converter may be suitable for reducing the reactive power exchange at the connection point.

In one embodiment, the sub-network can be galvanically isolated from the higher-level AC supply network, for example, by a transformer at the connection point. The sub-network itself can be designed without galvanic isolation, and in particular the at least one power converter can be connected to the sub-network without galvanic isolation.

### BRIEF DESCRIPTION OF THE FIGURES

The technical teaching according to the disclosure is further explained and described below with reference to embodiments illustrated in the figures.

FIG. 1 is a schematic view of a method for reducing harmonic power flows.

FIG. 2 is a schematic view of an embodiment of a sub-network with a power converter.

FIG. 3 is a schematic view of an embodiment of a control system with various components.

FIG. 4 is a schematic view of another embodiment of a sub-network with a power converter.

FIG. 5 is a schematic view of another embodiment of a sub-network with a power converter.

FIG. 6 is a schematic view of another embodiment of a control system with various components.

FIG. 7 is a schematic view of current and voltage curves, by way of example, in the sub-network.

FIG. 8 is a schematic view of another embodiment of a sub-network with a power converter and DC source.

FIG. 9 is a schematic view of another embodiment of a sub-network with a plurality of power converters.

The same reference signs are used in the figures for identical or similar elements. The representations in the figures may not be to scale.

### DETAILED DESCRIPTION

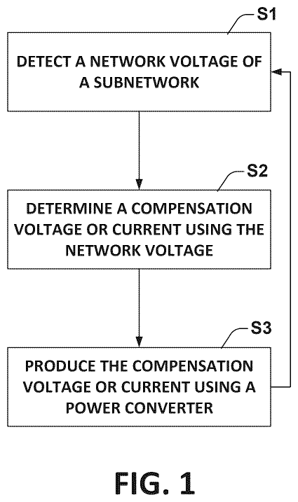

FIG. 1 schematically shows a method for reducing harmonic power flows via a connection point AP at which a sub-network 10 with a power converter 16, 16.N is connected to a higher-level AC supply network 12.

The method includes the following acts:
S1: detecting a network voltage U_{ac} of the subnetwork 10.
S2: determining a compensation voltage and/or a compensation current Komp using the network voltage U_{ac}.
S3: producing the compensation voltage and/or the compensation current Komp by means of the power converter 16, 16.N.

In one embodiment, the method is carried out repeatedly so that the continuous generation and adjustment of the compensation current and/or the compensation voltage Komp can reduce distortions from harmonics in the electrical power exchanged via the connection point.

The method is carried out, for example, by a control unit 20, 20.N configured as a computing circuit with memory and processor. The method can be executed on the control unit 20, 20.N, e.g. as software. Appropriate measuring devices may be provided for detecting measured values.

The compensation voltage and/or the compensation current Komp are determined using the method, e.g. by the control unit 20, such that they can be generated by the power converter 16, 16.N.

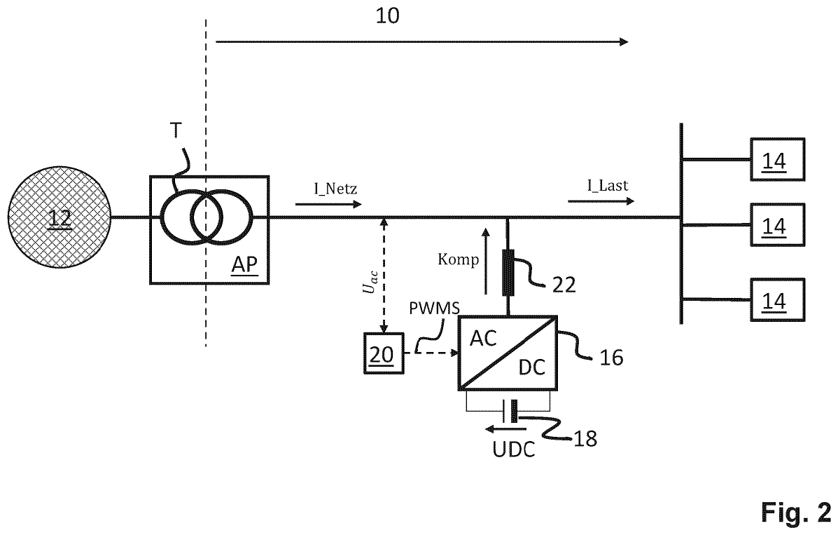

FIG. 2 schematically shows an embodiment of the sub-network 10 with the power converter 16. In the shown example, the sub-network 10 is configured as an AC sub-network with one cable strand. In the shown example, the sub-network 10 has three loads 14. More or fewer loads 14 are also conceivable. The loads 14 can, for example, be configured as AC loads or as DC loads which are connected to the sub-network 10 directly or via suitable converters.

The sub-network 10 is connected to the AC supply network 12 via the connection point AP. A network current I_Netz flows between the sub-network 10 and the higher-level AC supply network 12 via the connection point AP. For example, sub-network 10 can be configured in such a way that it does not require galvanic isolation within the sub-network 10. For example, the power converter 16 can be connected to the sub-network 10 without a transformer. The connection of the sub-network 10 to the AC supply network 12 via the connection point AP is implemented in this embodiment with galvanic isolation, for example, by a transformer T.

The loads 14 draw an electrical load current I_Last from the sub-network 10. The load current I_Last includes an active power current I_d at a network frequency f0 and a harmonic distortion current at one or more integer multiples of the network frequency f0. The load current I_Last may further include a reactive power current I_q at the network frequency f0.

The power converter 16 has an AC side and a DC side and can be operated bidirectionally, i.e. as an inverter and/or as a rectifier. The power converter 16 is configured to exchange, by means of a bridge circuit, electrical power between a capacitor 18 connected on its DC side and the sub-network 10 connected on its AC side. Electrical power can be stored in the capacitor 18 and drawn from it via the power converter 16. The connection of the power converter 16 to the sub-network 10 can be made, for example, via a filter inductor 22.

The control unit (or circuit) 20 detects the network voltage U_{ac} via a suitable measuring device and determines the compensation voltage and/or the compensation current Komp such that the compensation voltage and/or the compensation current Komp can be produced by a suitable clocking of the bridge circuit of the power converter 16. For example, a PWMS control signal can be used to generate the appropriate clocking of the bridge circuit, e.g. by pulse width modulation. The compensation voltage and/or the compensation current Komp generated in this way by the power converter 16 is suitable for reducing the harmonic distortion current at at least a multiple of the network frequency f0 in the network current I_Netz.

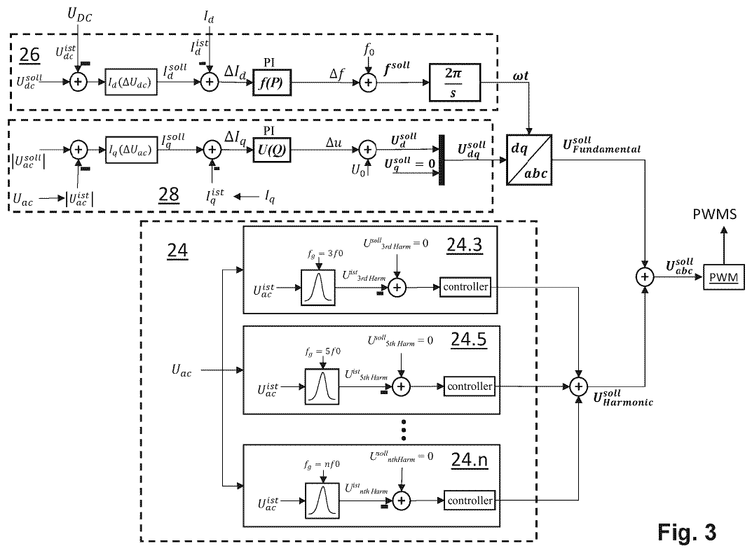

To start the power converter 16, the DC voltage UDC can first be ramped up by means of a pre-charging circuit (not shown) supplied from the AC side. When the DC voltage UDC is sufficiently pre-charged, the actual operation of the power converter 16 is started in order to reduce the harmonic power flows, and the DC voltage UDC is adjusted by means of a DC control (not shown in FIG. 2, but illustrated as a subcircuit of the control unit 20 in FIG. 3). Thereafter, during operation of the power converter 16 as described above, generating the compensation voltage and/or compensation current Komp can contribute to the harmonization of the network voltage U_{ac}.

FIG. 3 schematically shows an embodiment of a control system that can implement the described method. The control can, for example, take place at the control unit 20 and include various components. In the embodiment shown in FIG. 3, the control comprises three sub-aspects: harmonic control 24, DC control 26, and reactive power control 28 which can be active simultaneously.

In one embodiment, the DC control 26 and reactive power control 28 described below operate in the so-called dq system. This is obtained by transforming an abc system with time profiles of the individual phase voltages or phase currents into the dq system with symmetrical components and is regularly used for multi-phase alternating currents. The dq system regularly has the symmetrical components positive sequence system, negative sequence system and zero sequence system.

The DC control 26 can ensure a constant DC voltage UDC. In this case, the DC voltage on the DC side, for example, the DC voltage of a capacitor 18 or a plurality of capacitors 18 of the DC voltage intermediate circuit, is stabilized by suitable power exchange via the power converter 16 with the sub-network 10 connected on the AC side, by generating a positive sequence current, i.e. an active current, I_d, which adds or removes energy to or from the intermediate circuit capacitors, e.g. capacitor 18, depending on the deviation of the actual value

$${U}_{dc}^{ist}$$

of the DC voltage from a DC target voltage

$${U}_{dc}^{soll}$$

via an active current controller I_{d}(ΔU_{dc}).

Using the difference between the actual value

$${U}_{dc}^{ist}$$

of the DC voltage UDC and the specified level

$${U}_{dc}^{Soll}$$

of the DC voltage UDC, the active power current setpoint

$${I}_{d}^{soll}$$

for the active power is determined. The DC control 26 comprises an f(P) PI controller which uses as an input value a difference ΔI_{d} between an active power current setpoint

$${I}_{d}^{soll}$$

and an active power current actual value

$${I}_{d}^{ist}$$

of the active power exchanged via the bridge circuit of the power converter 16. The active power exchange via the bridge circuit of the power converter 16 is controlled by changing the AC-side frequency f^{soll} of the power converter 16 depending on the output value of the f(P) PI controller.

The reactive power control 28 reacts to the AC voltage amplitude |U_{ac}|, i.e. the amount of the network voltage U_{ac}. If the actual value

$$\vert {U}_{ac}^{ist} \vert$$

of the voltage amplitude |U_{ac}| is increased, reactive power is taken up by a reactive power current I_{q} generated by a reactive power current controller I_{q}(AU_{ac}). If the actual value

$$\vert {U}_{ac}^{ist} \vert$$

of the voltage amplitude |U_{ac}| is too low, reactive power is provided by the reactive power current I_{q} generated by the reactive power current controller I_{q}(AU_{ac}).

If the connected loads 14 in sub-network 10 are predominantly inductive, for example motors, reactive power is provided by the sub-network 10 for their operation. This reactive power interacts with inductors in the sub-network 10 and leads to an increased AC voltage amplitude |U_{ac}| in the sub-network 10. However, if the loads 14 are predominantly capacitive, reactive power is fed into the sub-network 10. This leads to a reduced AC voltage amplitude |U_{ac}|. By providing corresponding counter-current reactive power, the power converter 16 thus relieves the sub-network 10 from the reactive power exchange with the AC supply network 12 via the connection point AP.

The reactive power is provided in the embodiment shown in FIG. 3 by the power converter 16 generating a negative sequence current I_{q} which is then detected by measuring at the output of the power converter 16. The reactive power control 28 determines a reactive power control contribution to the compensation voltage Komp. For this purpose, the reactive power control 28 includes a U(Q) PI controller which uses, as an input value, a difference ΔI_{q} between a reactive power current setpoint

$${I}_{q}^{soll}$$

and a reactive power current actual value

$${I}_{q}^{ist}$$

of the reactive power exchanged via the bridge circuit of the power converter 16. The reactive power current setpoint

$${I}_{q}^{soll}$$

for the reactive power is specified depending on a difference between a setpoint

$$\vert {U}_{ac}^{soll} \vert$$

and an actual value

$$\vert {U}_{ac}^{ist} \vert$$

the magnitude of the network voltage |U_{ac}|. As an output value, the U(Q) PI controller generates a voltage difference Δu which, together with a specified voltage U₀, is used to produce a target effective voltage

$${U}_{d}^{soll} .$$

Together with a target reactive power voltage

$${U}_{q}^{soll} ,$$

the target voltage

$${U}_{dq}^{soll}$$

in the dq system is generated therefrom from zero.

The output values of DC control 26 and reactive power control 28 are transformed into the abc system and result in the network-frequency target voltage

$${U}_{Fundamental}^{Soll} .$$

There may be loads 14 that receive certain harmonics from the sub-network 10 via the load current I_Last. This causes a harmonic distortion current at one or more multiples of the network frequency f0. The harmonic control 24 has a respective harmonic controller 24.3, 24.5, 24.n for harmonics at a multiple or several multiples of the network frequency f0. In the example shown in FIG. 3, the harmonic control 24 has harmonic controllers for harmonics with three times the network frequency f0 (24.3), five times the network frequency f0 (24.5), and n times the network frequency f0 (24.n). In one embodiment, n is chosen as an odd natural number.

A respective harmonic controller 24.3, 24.5, 24.n filters the respective harmonic contribution

$${U}_{3 te Harm}^{ist} {U}_{5 te Harm}^{ist} {U}_{nte Harm}^{ist}$$

from the actual value

$${U}_{ac}^{ist}$$

of the network voltage U_{ac}. This is used as a control variable and is adjusted by corresponding setpoints

$${U}_{3 te Harm}^{Soll} = 0 ,$$

set to zero, for the harmonics.

The harmonic control 24 generates the harmonic contributions

$${U}_{Harmonic}^{Soll}$$

to the compensation voltage. These are combined with the network frequency target voltage

$${U}_{Fundamental}^{Soll}$$

from the DC control 26 and the reactive power control 28 in the abc system, and the target voltage

$${U}_{abc}^{Soll}$$

results in the abc system. Using the target voltage

$${U}_{abc}^{Soll}$$

in the abc system, the compensation voltage Komp is generated by the power converter 16. For this purpose, the control signal PWMS is generated by generating the control signal PWM. By means of the control signal PWMS, the semiconductor switches of the power converter 16 are suitably controlled, and the AC output voltage of the power converter 16 is suitably adjusted by a compensation voltage Komp. In the embodiment shown in FIG. 3, the compensation voltage Komp then subsequently generates a compensation current Komp.

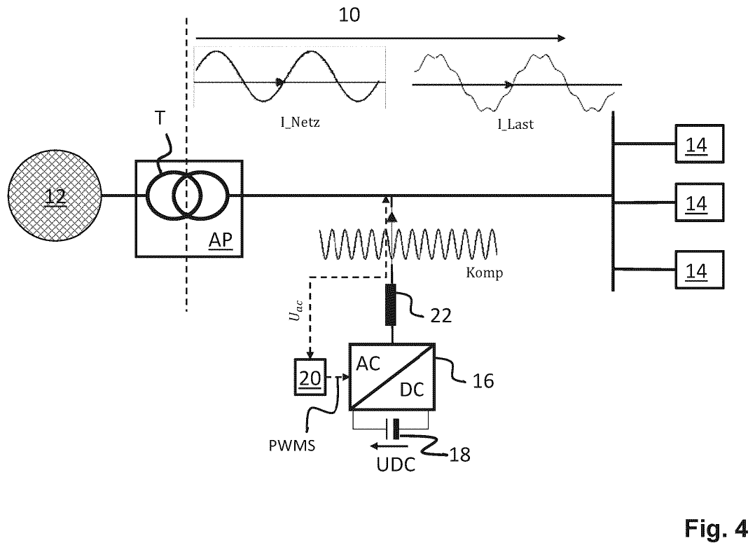

In FIG. 4, the upper part graphically shows, by way of example, time curves of network current I_Netz and load current I_Last. The compensation current Komp generated by the power converter 16 and symbolically represented at the output of the power converter 16 improves the quality of the network current I_Netz exchanged via the connection point AP. For example, harmonic power flows that are contained in the load current I_Last as harmonics are not provided via the connection point AP from the higher-level AC supply network 12, but from the power converter 16 so that the network current I_Netz has a basically sinusoidal shape with the network frequency, and the compensation current Komp corresponds to the harmonic distortion current in the load current I_Last.

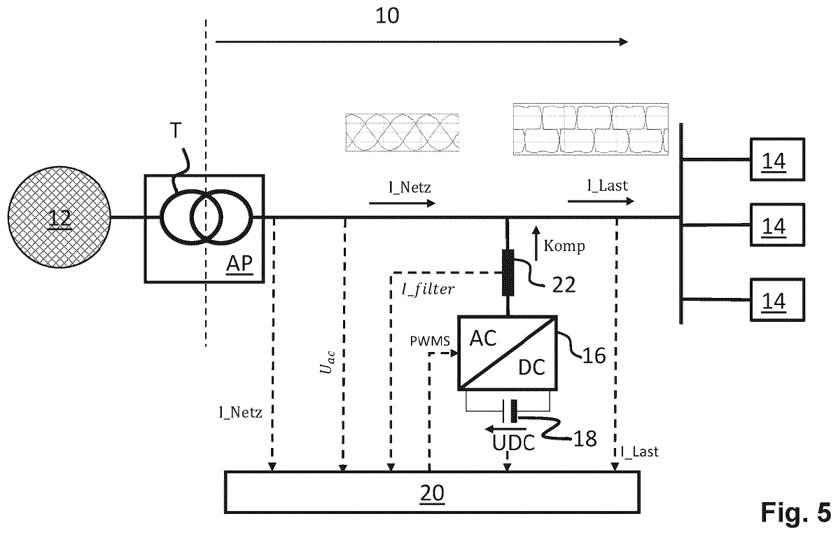

FIG. 5 schematically shows another embodiment of the sub-network 10 with a cable strand and the power converter 16 connected thereto. The control or computing unit (or circuit) 20 detects the network voltage U_{ac}, the network current I_Netz, a filter current I_filter, the DC voltage UDC and the load current I_Last using suitable measuring devices.

The control unit 20 determines the compensation voltage and/or the compensation current Komp such that the compensation voltage and/or the compensation current Komp can be produced by a suitable clocking of the bridge circuit of the power converter 16. The control signal PWMS can be used to generate e.g. the appropriate clocking of the bridge circuit, e.g. by pulse width modulation.

Also, in this embodiment, the harmonic distortion current of the load current I_Last can be supplied by the power converter 16 and does not have to be supplied, or not completely, from the AC supply network 12. Thus, the AC supply network 12 and the electrical power exchanged via the connection point AP can be relieved of the harmonic distortion current so that the harmonic power flows via the connection point AP are reduced. For this purpose, the network current I_Netz is measured “before” and the load current I_Last “behind” the power converter 16. In this case, the power converter 16 acts like a filter that can “filter out” harmonics from the network current I_Netz occurring without higher-level specifications.

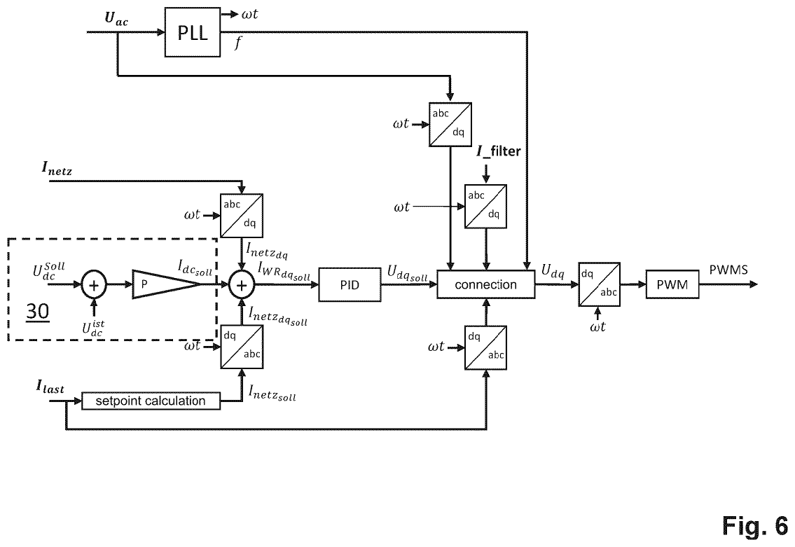

FIG. 6 schematically shows an embodiment of a control system or circuit that can implement the method according to the application and can run, for example, in the control unit or circuit 20.

A DC control 30 comprises a proportional controller (P controller) P which uses, as an input value, a difference between an actual value

$${U}_{dc}^{ist}$$

of the DC voltage UDC and the specified level

$${U}_{dc}^{Soll}$$

of the DC voltage UDC. As an output value, the P controller P outputs a DC current I_{dc}_{ₛₒₗₗ} which is suitable for stabilizing and/or reducing the difference between the actual and setpoint value of the DC voltage UDC, so that the DC voltage UDC is regulated to a specifiable level.

Using the load current I_Last, a network current setpoint I_{netz}_{ₛₒₗₗ} is determined in the time domain and transformed from the abc system to the dq system. This results in the network current setpoint in the dq system

$${I}_{{netz}_{{dq}_{soll}}} .$$

Determining the network current setpoint I_{netz}_{ₛₒₗₗ} may include a bandpass filtering of the load current I_Last in the time domain, the center frequency of the bandpass depending on the network frequency f0 and being able to correspond to the network frequency f0. The resulting network current setpoint

$${I}_{{netz}_{{dq}_{soll}}}$$

then essentially corresponds to the desired sinusoidal curve of the network current I_Netz at the network frequency f0, i.e. the load current I_Last less any harmonic distortion currents.

The detected network current I_Netz is also transformed from the abc system into the dq system and results in the network current I_{netz}_{_{dq}} in the dq system.

Depending on the actual value I_{netz}_{_{dq}} of the network current and the network current setpoint

$${I}_{{netz}_{{dq}_{soll}}}$$

and the output value of the DC control 30, namely the DC current I_{dc}_{ₛₒₗₗ}, a current setpoint is first set in the dq system

$${I}_{{netz}_{{dq}_{soll}}} ,$$

and then the target output voltage U_{dq}_{ₛₒₗₗ} of the power converter 16 in the dq system is determined via a proportional-integral-derivative controller (PID controller) PID. In particular, a difference between the network current setpoint

$${I}_{{netz}_{{dq}_{soll}}}$$

and network current actual value I_{netz}_{_{dq}} can be determined and added to the DC current I_{dc}_{ₛₒₗₗ}. This sum is then fed to the PID controller PID as the current setpoint in the dq system

$${I}_{{netz}_{{dq}_{soll}}} ,$$

which controller outputs, at its output, the target output voltage U_{dq}_{ₛₒₗₗ} which is suitable for generating a compensation current Komp which includes both any harmonic distortion currents and any active currents for regulating the DC voltage UDC.

The control portion of the control unit or circuit 20 also has a connection which can be used to pre-control the output voltage U_dq of the power converter 16. The input value of the connection is the target output voltage U_{dq}_{ₛₒₗₗ} of the power converter 16. The other input variables include the load current I_Last which was transformed from the abc system to the dq system, the network voltage U_{ac} which was transformed from the abc system to the dq system, the frequency of the network voltage U_{ac}, as well as the output current I_filter of the power converter 16. The connection of these quantities to the target output voltage U_{dq}_{ₛₒₗₗ} allows changes in the various input variables of the control system to be taken into account even before these changes have had a concrete effect on the target output voltage along the control path. For example, the pre-control using the output current I_filter as well as the load current I_Last and the network voltage U_{ac} can enable a faster response of the control system to, for example, externally induced changes in the output current I_filter of the power converter 16. In addition, the connection compensates for the influence of periodically fluctuating AC variables on the DC control so that a P controller is sufficient for the DC control, it being possible for the dynamic behavior of the DC voltage to be further improved by means of a high proportionality factor.

The initial value of the connection is the output voltage U_dq of the power converter 16. The output voltage U_dq of the power converter 16, which is subsequently transformed from the dq system into the abc system, is used by the control signal generator PWM to generate the control signal PWMS for the bridge circuit of the power converter 16. The bridge circuit is clocked depending on the control signal PWMS in order to generate the compensation current Komp. In this case, in the embodiment shown in FIGS. 5 and 6, the compensation current Komp is linked to a compensation voltage Komp which results in the control according to FIG. 6 such that the filter current I_filter fed in by the power converter 16 includes both any harmonic distortion currents and any active currents for regulating the DC voltage UDC.

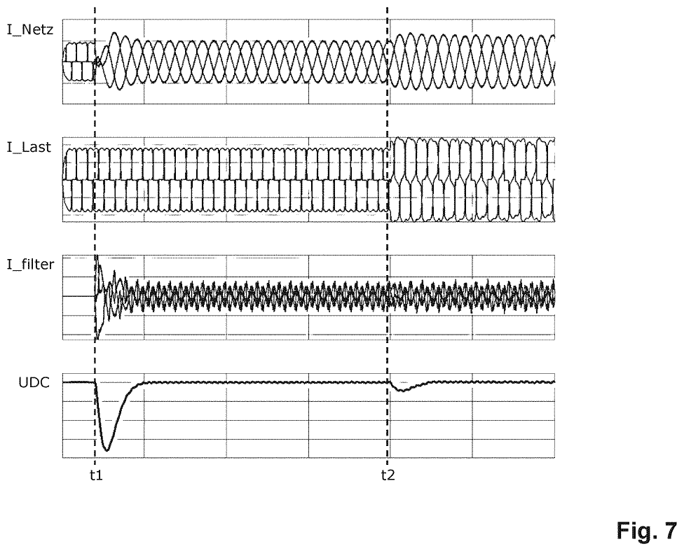

FIG. 7 shows schematic representations, by way of example, of network current I_Netz, load current I_Last, output current of the power converter I_filter, as well as the DC voltage UDC.

It can be seen that the load current I_Last corresponds to the network current I_Netz via the connection point AP when the power converter 16 is inactive. In the representation by way of example in FIG. 7, this corresponds to the period t<t1 in which both the load current I_Last as well as the network current I_Netz include a harmonic distortion current in addition to a network frequency fundamental wave, while the filter current I_filter is zero.

At time t1, the power converter 16 is activated and executes a method according to the application for reducing the harmonic power flows in the network current I_Netz. In a short transient phase, the DC voltage UDC drops briefly and is raised back to a normal level by the utilized DC control. In the steady state in the period between t1 and t2, the harmonic distortion currents in the load current I_Last are taken over by the power converter 16 and fed in as the filter currents I_filter so that the network current I_Netz basically only comprises the sinusoidal network frequency fundamental wave.

At time t2, the load current I_Last changes, and another short transient phase follows with a regulation of the briefly dipping DC voltage UDC. In this case, the transient phase can be shortened, for example, by means of the pre-control according to FIG. 6. Subsequently, the harmonic power flows at the connection point of the AP are again reduced, by transferring the harmonic distortion currents in the load current I_Last from the power converter 16 and feed in as filter currents I_filter.

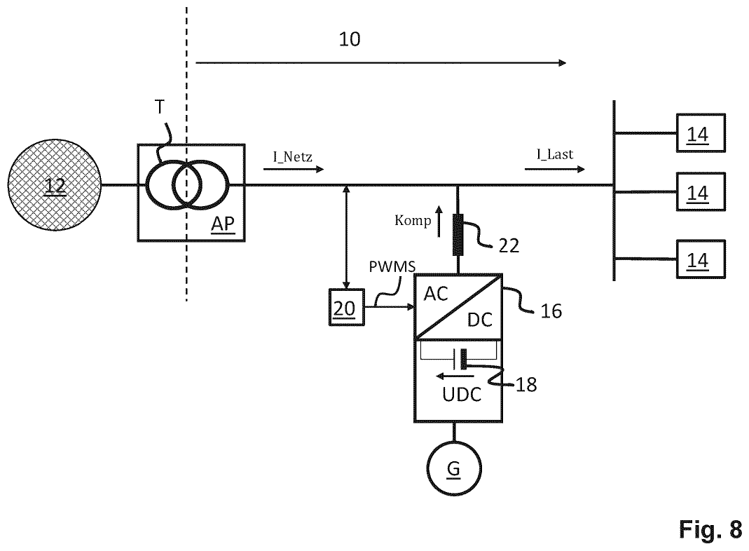

FIG. 8 shows an embodiment in which the power converter 16 has a connected DC source G. The previously described methods and controls can be supplemented here by feeding in electrical active power from the DC source G. For example, the power converter 16 can perform an AC current-controlled feed-in from a PV system that acts as a DC source G, with a selective network forming function. A power converter 16 configured as a PV inverter 16 can feed PV power into the sub-network 10 in the form of AC active power in a voltage-controlled manner, e.g. in a network-following/current-injecting/current-regulated manner, and can also, within the scope of its capabilities, exert a targeted influence on certain harmonics, e.g. by means of a voltage-injecting harmonic control according to FIG. 3 or a current-injecting filtering according to FIG. 6.

In this case, the active power of a PV generator can be fed into the AC supply network via AC current-controlled operation with the network frequency f0. In addition, the power converter 16 can feed a compensation voltage and/or a compensation current Komp into the sub-network 10, which compensates for one or more AC harmonics in their frequency, e.g. the 3rd, 5th, 7th, 9th, 11th, 13th harmonics, etc., with the aim of minimizing these AC harmonics at the connection point AP to the AC supply network 12. This allows the power converter 16, e.g. PV inverter 16, to be used specifically as an active network filter. In addition, it can be decided whether the permissible apparent power of the power converter 16 should be used to feed the full power of the DC source G as active power into the AC network, or whether parts of the permissible apparent power of the power converter 16 should be used to reduce the distortion current in the network current I_Netz. Such a distortion current can be generated, for example, by a load 14 which can be, for example, a large consumer among the consumers 14. As a result, the power converter 16 can contribute to maintaining limit values with regard to THD (total harmonic distortion) and/or harmonics, in particular at the connection point AP, which would otherwise be exceeded by the operation of the load 14 in the form of the large consumer. Such behavior can be appropriately remunerated, for example, by the large consumer and/or the network operator of the AC supply network.

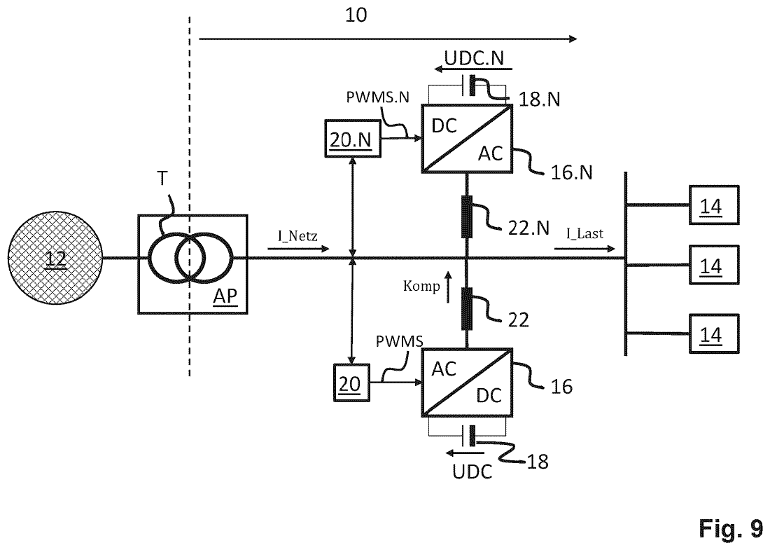

FIG. 9 shows an embodiment of the sub-network 10 with a plurality of power converters 16, 16.N. The power converters 16, 16.N can have capacitors 18, 18.N connected to their respective DC sides to which DC voltages UDC, UDC.N are applied. On the AC side, the power converters 16, 16.N can be connected to the sub-network 10 via filter inductors 22. Each power converter 16, 16.N may have a control unit (or circuit) 20, 20.N. A higher-level control unit is also conceivable which alternatively or additionally controls both and possibly further power converters 16, 16.N, for example by specifying individual parameters of the controls in the power converter 16, 16.N, and/or executes the previously described methods and controls.

The power converters 16, 16.N can be connected in parallel on the AC side of the sub-network 10. Different sub-functions, e.g. concerning the sub-aspects of harmonic control 24, DC control 26, 30 and reactive power control 28, can be fulfilled by different power converters 16, 16.N. It is also conceivable that a plurality of power converters 16, 16.N fulfill the same sub-function. For example, a first number of power converters 16, 16.N can take over the reduction of harmonics in the network current I_Netz, for example, each power converter 16, 16.N being able to reduce a specific harmonic; at the same time, a second number of power converters 16, 16.N can perform reactive power compensation. As a result, the power converters 16, 16.N are each subjected to less load and can be protected with a view to increasing their service life.

What is claimed is:

1. A method for reducing harmonic power flows via a connection point at which a sub-network is connected to a higher-level AC supply network and via which a network current flows between the sub-network and the higher-level AC supply network,
wherein the sub-network has at least one load which draws, from the sub-network, an electrical load current which comprises an active power current at a network frequency and a harmonic distortion current at one or more integer multiples of the network frequency, wherein the sub-network comprises a power converter comprising a bridge circuit that exchanges electrical power between a capacitor connected on a DC side of the power converter and the sub-network connected on an AC side of the power converter,
and wherein, using a control circuit, the method comprises:
detecting a network voltage of the sub-network,
determining a compensation voltage or a compensation current, or both, using the detected network voltage, wherein the compensation voltage or the compensation current is suitable for reducing the harmonic distortion current at at least one multiple of the network frequency in the network current, and
producing the compensation voltage or the compensation current, or both, using the power converter by suitable clocking of the bridge circuit in the power converter.

2. The method according to claim 1, wherein when determining the compensation voltage or the compensation current, or both, different harmonics of the harmonic distortion current at different multiples of the network frequency are taken into account independently of one another.

3. The method according to claim 2, wherein the control circuit comprises a respective harmonic controller configured to determine a respective harmonic contribution to the harmonic distortion current using the network voltage and, using the respective harmonic contribution as a control variable, determine a respective harmonic compensation contribution to the compensation voltage.

4. The method according to claim 1, wherein a DC voltage is detected by the control circuit which is applied to the capacitor connected on the DC side of the power converter, and wherein the control circuit comprises a DC controller configured to determine a DC control contribution to the compensation voltage or to the compensation current, or both, using the detected DC voltage such that the detected DC voltage is regulated to a predetermined level by suitable active power exchange via the bridge circuit.

5. The method according to claim 4, wherein the DC controller comprises an f(P) PI controller which uses, as an input value, a difference between an active power current setpoint and an active power current actual value of the active power exchanged via the bridge circuit, wherein the active power current setpoint is determined based on a difference between an actual value of the DC voltage and a specified or target level of the DC voltage, and wherein an active power exchange via the bridge circuit is controlled by changing an AC-side frequency of the power converter depending on an output value of the f(P) PI controller.

6. The method according to claim 4, wherein the DC controller comprises a P controller which uses, as an input value, a difference between an actual value of the DC voltage and a specified or target level of the DC voltage, and wherein the active power exchange via the bridge circuit is controlled by specifying a current setpoint depending on an output value of the P controller.

7. The method according to claim 4, wherein the electrical load current comprises a reactive power current at the network frequency, and wherein the control circuit comprises a reactive power control configured to determine a reactive power control contribution to the compensation voltage, wherein the reactive power control comprises a U(Q) PI controller which uses, as an input value, a difference between a reactive power current setpoint and a reactive power current actual value of the reactive power exchanged via the bridge circuit, wherein the reactive power current setpoint is specified for the reactive power depending on a difference between a setpoint and an actual value of the network voltage in such a way that a reactive power exchange at the connection point is reduced.

8. The method according to claim 1, wherein the method, using the control circuit, further comprises:
detecting the load current and the network current,
determining a network current setpoint using the load current,
determining a target output voltage of the power converter depending on a difference between a network current actual value and the network current setpoint, and
producing a control signal from the determined target output voltage and clocking the bridge circuit based on the control signal in order for the power converter to produce the compensation current.

9. The method according to claim 8, wherein the determination of the network current setpoint comprises a bandpass filtering of the load current, wherein the bandpass filtering comprises a bandpass filter, and wherein a center frequency of the bandpass filter depends on the network frequency.

10. The method according to claim 1, wherein the load current, an output current of the power converter and/or the network voltage are detected by the control circuit and used to pre-control an output voltage of the power converter.

11. A control circuit configured to reduce harmonic power flows via a connection point of a sub-network to a higher-level AC supply network, wherein a network current flows between the sub-network and the higher-level AC supply network via the connection point, wherein the sub-network has at least one load which draws a load current from the sub-network, which load current comprises an active power current at a network frequency and a harmonic distortion current at one or more integer multiples of the network frequency, wherein the sub-network also comprises a power converter which comprises a bridge circuit configured to exchange electrical power between a capacitor connected on a DC side of the power converter and the sub-network connected on an AC side of the power converter,
wherein the control circuit is configured to:
receive a network voltage of the sub-network,
determine a compensation voltage or a compensation current, or both, using the received network voltage, wherein the determined compensation voltage or the compensation current, or both, is subsequently generated by the power converter and is suitable for reducing the harmonic distortion current at at least a multiple of the network frequency in the network current, and
output a control signal to the power converter based on the determined compensation voltage or compensation current, or both, wherein the compensation voltage or the compensation current, or both, is generated by the power converter using the control signal by suitable clocking of the bridge circuit in the power converter.

12. The control circuit according to claim 11, wherein the control circuit is configured to determine a respective harmonic compensation contribution to the compensation voltage for various harmonic contributions at different multiples of the network frequency independently of each other.

13. The control circuit according to claim 12, wherein the control circuit comprises respective harmonic controllers configured to determine the respective harmonic contribution using the network voltage, wherein using the determined respective harmonic contribution as a control variable, the respective harmonic controller determine the respective harmonic compensation contribution to the compensation voltage.

14. The control circuit according to claim 11, wherein the control circuit is configured to receive a DC voltage which is applied to the capacitor connected on the DC side of the power converter, and wherein the control circuit comprises a DC controller configured to determine a DC control contribution to the compensation voltage or compensation current, or both, using the DC voltage in such a way that the DC voltage is regulated to a predetermined level by suitable active power exchange via the bridge circuit.

15. The control circuit according to claim 11, wherein the load current has a reactive power current at the network frequency, and wherein the control unit is configured to carry out a reactive power control, by means of which a reactive power control contribution to the compensation voltage can be determined in such a way that the reactive power exchange at the connection point is reduced.

16. A sub-network comprising a control circuit according to claim 11,
wherein the sub-network is connected to the higher-level AC supply network at the connection point,
wherein the sub-network comprises at least one load configured to draw the load current from the sub-network, which load current comprises the active power current at a network frequency and the harmonic distortion current at one or more integer multiples of the network frequency,
wherein the sub-network further comprises the power converter which is configured to exchange electrical power between the capacitor connected on its DC side and the sub-network connected on its AC side using the bridge circuit in such a way that harmonic power flows via the connection point are reduced.

17. The sub-network according to claim 16, wherein the sub-network comprises a plurality of power converters, wherein the plurality of power converters are each configured to produce a compensation voltage or a compensation current, or both, for reducing respective, different harmonic contributions in each case at different multiples of the network frequency.

18. The sub-network according to claim 17, wherein the power converters are connected to a higher-level control circuit, and the higher-level control circuit outputs a respective control signal to a respective one of the plurality of power converters, wherein:
the respective control signal is configured to generate the compensation voltage or the compensation current, or both, by the respective one of the plurality of power converters in order to reduce the harmonic distortion current at one or more multiples of the network frequency or to reduce a reactive power exchange at the connection point, or both.

19. The sub-network according to claim 16, wherein the sub-network is galvanically isolated from the higher-level AC supply network by a transformer at the connection point.

20. The sub-network according to claim 16, wherein the power converter is connected to the sub-network without galvanic isolation.
